(19) United States
(12) Patent Application Publication
(10) Pub. No.: US 2021/0230459 A1
(43) Pub. Date: Jul. 29, 2021

(54) ADDITIVE COMPOSITION FOR AQUEOUS DISPERSIONS OF HYDROPHOBIC POLYMERS

(71) Applicant: BASF SE, Ludwigshafen am Rhein (DE)

(72) Inventors: Bernd HOEVEL, Ludwigshafen (DE); Karl-Heinz SCHUMACHER, Ludwigshafen (DE)

(73) Assignee: BASF SE, Ludwigshafen am Rhein (DE)

(21) Appl. No.: 17/047,246

(22) PCT Filed: Apr. 10, 2019
(86) PCT No.: PCT/EP2019/059040

§ 371 Date: Oct. 13, 2020

(30) Foreign Application Priority Data
Apr. 20, 2018 (EP) 18168541.3

(51) Int. Cl. C09J 11/08; C09J 135/06; C09J 133/08; C08K 9/06; C08K 5/41; C08K 3/36; C08L 33/08; B32B 37/12; B32B 7/12; B32B 27/08

(52) U.S. Cl. CPC C09J 11/08; B32B 2405/00; C09J 133/08; C08K 9/06; C08K 5/41; C08K 3/36; C08L 33/08; B32B 37/12; B32B 7/12; B32B 27/08; B32B 2307/412; B32B 2250/02; B32B 2255/10; B32B 2255/26; B32B 2307/73; C09J 135/06

(57) ABSTRACT

Described are compositions comprising a defoamer mixture comprising mineral oil and hydrophobic particles such as for example wax particles; di- or monoalkyl sulfosuccinate having at least 9 carbon atoms in the alkyl group and certain ethylene oxide/propylene oxide block copolymers. Also described are aqueous dispersions of hydrophobic polymers comprising these compositions and the use of the aqueous polymer dispersions as an adhesive, for example for producing composite films from transparent polymer films.

The invention relates to compositions comprising a defoamer/wetting agent mixture based on aromatics-free white oils or natural fatty acid oils and hydrophobic particles, certain long-chain di- or monoalkyl sulfosuccinates and certain ethylene oxide/propylene oxide block copolymers. Also described are aqueous dispersions of hydrophobic polymers comprising these compositions and the use of the aqueous polymer dispersions as an adhesive, for example for producing composite films from transparent polymer films.

Of interest are additives or additive compositions suitable as a formulation additive for hydrophobic, low-emulsifier aqueous emulsion polymers for production of ideally defect-free adhesive coatings. Aqueous emulsion polymers are applied to carrier films using suitable application systems as laminating or pressure-sensitive adhesives and are intended to result in an ideally defect-free clear coating pattern, especially when the carrier films are transparent. In customary application systems (for example gravure rollers, flexography, jets, curtain coaters) there is a risk that the emulsion polymers form foam, which becomes disruptively apparent as a discernible structure in the dried film, as a result of mechanical influences (pumps, rotating rollers). A further cause of undesired structures in the coating pattern may result from the aqueous emulsion polymer not wetting the carrier film over its entire surface. This problem occurs especially in the case of hydrophobic film surfaces.

In order to avoid undesired film structures due to foam or insufficient wetting, the emulsion polymers are typically admixed with a formulation package of defoaming agents and wetting agents. This must take account of the following risks: since the wetting agent has an amphiphilic structure it itself contributes to foam formation. On the other hand the defoaming agent has a propensity for producing wetting defects or, through separation, generating an orange peel-like structure in the dispersion film. The choice of suitable components is thus of particular importance. A further challenge is that of ensuring that the formulation package remains effective even over a longer storage time of the aqueous adhesive. This is not the case if the defoaming agent in the aqueous adhesive separates by accumulating at the surface of the adhesive polymer particles for example and then cannot be re-homogenized by stirring. This problem occurs especially when the emulsion polymers are hydrophobic and stabilized with a small amount of emulsifier. Hydrophobic, low-emulsifier polymer dispersions are employed especially as laminating adhesives in composite film lamination because they produce high adhesive bond strengths and are also usually cost-effective to produce. Combinations of n-butyl acrylate and styrene are especially to be found here.

Known defoamers include for example silicone defoamers or mineral oil defoamers. In the case of hydrophobic polymer dispersions (defined by a free surface energy of the dried polymer films of less than 35 mN/m) the use of silicone defoamers often results in clearly visible structures in the dried polymer film (see table 1). Although mineral oil defoamers do not exhibit this problem they do have a propensity for fast separation in the hydrophobic polymer dispersions and are often no longer homogenizable after a number of days, even though this is a precondition for foam suppression. Oil defoamers comprising wax particles are strongly hydrophobic and therefore very difficult to incorporate into the polymer dispersions, these materials also having a propensity for causing film defects (see table 1). The choice of wetting agent is therefore of great importance for the successful use of such defoamers. Dialkyl sulfosuccinates are known emulsifiers. However, regular sulfosuccinates having relatively short fatty acid radicals, for example dihexyl and diisooctyl sulfosuccinates, have proven to exhibit severe foaming upon incorporation of the highly hydrophobic white oil/wax defoamers into aqueous polymer dispersions (see table 2). While sulfosuccinates having higher fatty acid chains may be sufficiently emulsifying and exhibit markedly less foaming they are unfortunately not always capable of ensuring complete wetting of polymer film substrates.

EP 2 930 206 A1 describes aqueous polymer dispersions comprising polyethylene oxide as an additive. EP 0 878 224 A1 describes defoamer compounds composed of alkoxylated partial esters of oligoglycerols for defoaming of polymer dispersions and aqueous paint systems. EP 0 322 830 describes a defoamer based on an oil-in-water emulsion. US2013/0160676 A1 describes a defoaming wetting agent based on EO-PO block copolymers for aqueous coating systems.

The present invention accordingly had for its object to provide a formulation package for hydrophobic aqueous polymer dispersions which not only has a good defoaming activity but also ensures the best possible wetting of polymer films and ideally defect-free coating of polymer films, especially for the production of transparent composite films.

The object was achieved by a composition comprising

(A) at least one defoamer mixture comprising (i) at least one oil selected from aromatics-free white oils and natural fatty acid oils and (ii) hydrophobic particles, preferably wax particles or hydrophobized silica particles; (B) at least one di- or monoalkyl sulfosuccinate, wherein the alkyl groups each have at least 9 carbon atoms; and

(C) at least one ethylene oxide/propylene oxide block copolymer having a molecular weight of 1000 to 3000 and an ethylene oxide proportion of 10% to 40% by weight, preferably 15% to 30% by weight, based on the block copolymer.

The molecular weight may be calculated from the OH number.

To defoam hydrophobic polymer dispersions the defoamers must be sufficiently hydrophobic to ensure suitable defoaming and they must be sufficiently compatible to ensure long-term stabilization of the defoaming and not separate over time. According to the invention defoamers comprising both mineral oils (preferably white oils) and emulsified wax particles instead of otherwise customary silica particles as an additional constituent have proven successful.

Surprisingly, such defoamers were also superior to silicone oil defoamers which eventually lose their effectiveness (see table 4.2). It is thought that the wax particles endure for longer and are not separated from the polymer dispersion particles.

However, such defoamers are very difficult to incorporate and also have a propensity for causing film defects when employed without further measures (see table 1, experiments 4 and 5). The choice of wetting agents is therefore of particular importance for the successful use of such defoamers. Sulfosuccinates having relatively short fatty acid radicals, for example dihexyl and diisooctyl sulfosuccinates, have proven inadequately emulsifying for incorporation of the highly hydrophobic white oil/wax defoamers into aqueous polymer dispersions. Sulfosuccinates having higher fatty acid chains, for example didodecyl sulfosuccinate, have been successfully tested as sufficiently emulsifying but have proven inadequate for complete wetting of polymer film substrates with hydrophobic aqueous polymer dispersions when employed without further measures (see table 2).

It has now been found that such higher-chain sulfosuccinates may be successfully combined with low molecular weight propylene oxide/ethylene oxide block copolymers (molecular weight of 1000-3000 Da).

In particular, good wetting was achievable with propylene oxide/ethylene oxide block copolymers having an ethylene oxide proportion of 20-30% by weight. This is particularly surprising since this class of materials taken alone is not capable of achieving suitable substrate wetting since the surface tension of these block polyethers (measured in aqueous solution) is relatively high at approximately 40-41 mN/m and is thus still above the free surface energy of the hydrophobic polymers of the aqueous polymer dispersion.

The weight ratio of defoamer mixture (A), di- or monoalkyl sulfosuccinate (B) and ethylene oxide/propylene oxide block copolymer (C) is preferably 0.8 to 1.2 parts by weight, preferably 0.9 to 1.1 parts by weight, of defoamer mixture (A), 1.6 to 2.4 parts by weight, preferably 0.9 to 1.1 parts by weight, of the at least one di- or monoalkyl sulfosuccinate (B) and 0.8 to 1.2 parts by weight, preferably 0.9 to 1.1 parts by weight, of the at least one ethylene oxide/propylene oxide block copolymer (C).

The composition according to the invention comprises a defoamer mixture comprising (i) at least one oil selected from aromatics-free white oils and natural fatty acid oils and (ii) hydrophobic particles such as for example wax particles. White oils are hydrocarbons liquid at room temperature, for example paraffin oils, consisting predominantly of alkanes and cycloalkanes. The amount of white oils and fatty acid oils in the defoamer mixture is preferably from 80% to 90% by weight. The amount of hydrophobic particles in the defoamer mixture is preferably from 1% to 9% by weight. The defoamer mixture may additionally further comprise additives and solvents, for example up to 1-5% by weight of surface-active substances such as for example alkyl ethoxylates or glycerol ethers or up to 1-5% by weight of solvent such as for example polypropylene glycol.

White oils are purified mixtures of liquid, transparent, saturated hydrocarbons (so-called white mineral oil having CAS number 8042-47-5).

Hydrophobic particles are particles having a free surface energy of preferably not more than 25 mN/m. Typical hydrophobic particles are for example wax particles, preferably micronized waxes such as for example distearyl ethylenediamide, paraffin waxes, ester waxes, fatty alcohol waxes and fatty acid amides. Paraffin wax is preferred. One group of preferred compounds are polyethylene waxes having a weight-average molecular weight of preferably at least 2000. Polyethylene waxes have a melting point of preferably more than 90° C. Suitable hydrophobic particles also include hydrophobized silica particles, fatty acid salts, for example calcium soaps, especially calcium stearate, and polytetrafluoroethylene (PTFE) particles. Wax particles and hydrophobized silica particles are particularly preferred.

Suitable defoamer mixtures are for example Foamaster® WO 2310. Foamaster® WO 2323 and Foamaster® NO 2331.

The composition according to the invention comprises at least one di- or monoalkyl sulfosuccinate, wherein the alkyl groups each have at least 9 carbon atoms. Dialkyl sulfosuccinates are salts of sulfosuccinic acid dialkyl esters. Preference is given to metal salts, in particular alkali metal salts, particularly preferably the sodium salt. The alkyl groups preferably have at least 10 carbon atoms, for example 10 to 20 carbon atoms or 10 to 14 carbon atoms, particularly preferably 10 or 12 carbon atoms. Preferred alkyl groups are decyl, isodecyl and dodecyl. The sodium salts of diisodecyl sulfosuccinate and didodecyl sulfosuccinate are particularly preferred. The di- or monoalkyl sulfosuccinates preferably have a molecular weight of more than 500.

The composition according to the invention comprises at least one ethylene oxide/propylene oxide block copolymer having a molecular weight of 1000 to 3000, preferably 1500 to 3000 or 2000 to 3000 (determinable via the OH number) and an ethylene oxide proportion of 10% to 40% by weight, preferably 15% to 30% by weight, based on the block copolymer.

Suitable ethylene oxide/propylene oxide block copolymers are for example poloxamers.

Poloxamers are surfactant-like block copolymers of ethylene oxide and propylene oxide having a central polypropylene oxide portion which is bonded at both chain ends to a respective polyethylene oxide portion. The polyethylene oxide portion of the polymer is water soluble but the polypropylene oxide portion is not, thus resulting in amphiphilic properties. Depending on the degree of ethoxylation, they are liquid, pasty or solid.

Suitable block copolymers are for example those of general formula

HO—(CH₂CH₂O—)ₐ—(CH(CH₃)CH₂O—)_{b}(CH₂CH₂O—), —H

wherein a is not less than 2, preferably not less than 8, and indicates the degree of ethoxylation and b is not less than 2, preferably not less than 30, and indicates the degree of propoxylation, for example a=5 to 15 and b=10 to 50, preferably a is from 8 to 13 and b is from 20 to 40. It is particularly preferable when the number of ethylene oxide units is less than the number of propylene oxide units. Preference is given to ethylene oxide/propylene oxide block copolymers having a surface tension of not less than 40 mN/m, particularly preferably of 40 to 45 mN/m, measured in solution in distilled water at room temperature (23° C.) and at a concentration of 1 g/l according to DIN EN 14370:2004-11. The cloud point according to DIN EN 1890:2006 of the ethylene oxide/propylene oxide block copolymers is preferably above 23° C., particularly preferably from 27° C. to 36° C. Ethylene oxide/propylene oxide block copolymers are commercially available for example under the names Pluronic® or Hydropalat®, for example Hydropalata® WE 3161, WE 3162 or WE 3164.

The compositions according to the invention are preferably used as a formulation additive for aqueous dispersions of hydrophobic polymers (subsequently referred to as polymer dispersions). In the context of the present invention hydrophobic polymers are polymers having a free surface energy of less than 35 mN/m. The free surface energy is the free surface energy of the dried dispersion films determined by contact angle measurements with reference liquids (see examples for measurement) which correlates closely with the surface energy of the dispersion particles.

The polymer dispersions are preferably low-emulsifier dispersions in the sense that they comprise less than 1% by weight of emulsifiers that are distinct from the components (B) and (C) and have a surface tension of less than 25 mN/m.

The text below occasionally uses the designation “(meth)acrylic” or “(meth)acrylate” and similar designations as an abbreviating notation for “acrylic or methacrylic” or “acrylate or methacrylate”. In the designation Cx-alkyl (meth)acrylate and analogous designations, x denotes the number of carbon atoms in the alkyl group.

The glass transition temperature is determined by differential scanning calorimetry (ASTM D 3418-08, midpoint temperature). The glass transition temperature of the polymer in the polymer dispersion is the glass transition temperature obtained when evaluating the second heating curve (heating rate 20° C./min).

Particle diameters and particle size distribution are measured by photon correlation spectroscopy (ISO standard 13321:1996).

The aqueous polymer dispersion preferably comprises at least one polymer produced from

a) at least 60% by weight, based on the total amount of monomers, of at least one monomer selected from the group consisting of C1-to C20-alkyl acrylates, C1-to C20-alkyl methacrylates, vinyl esters of carboxylic acids comprising up to 20 carbon atoms, vinylaromatics having up to 20 carbon atoms, vinyl halides, vinyl ethers of alcohols comprising 1 to 10 carbon atoms, aliphatic hydrocarbons having 2 to 8 carbon atoms and one or two double bonds, and mixtures of these monomers,

b) at least 0.1 wt %, based on the total amount of monomers, of at least one monomer having at least one acid group; and

c) optionally at least one further monomer distinct from the monomers a) and b).

Monomers a)

The monomer mixture preferably consists of at least 60% by weight, preferably at least 80% by weight, for example from 80% to 99.9% by weight, particularly preferably at least 90% by weight, based on the total amount of monomers, of at least one monomer a) selected from the group consisting of C1-to 20-alkyl acrylates, C1-to 20-alkyl methacrylates, vinyl esters of carboxylic acids comprising up to 20 carbon atoms, vinylaromatics having up to 20 carbon atoms, vinyl halides, vinyl ethers of alcohols comprising 1 to 10 carbon atoms, aliphatic hydrocarbons having 2 to 8 carbon atoms and one or two double bonds, and mixtures of these monomers.

Suitable monomers a) are, for example, (meth)acrylic acid alkyl esters with a C₁-C₁₀-alkyl radical, such as methyl methacrylate, methyl acrylate, n-butyl acrylate, ethyl acrylate and 2-ethylhexyl acrylate, and also behenyl (meth)acrylate, isobutyl acrylate, tert-butyl (meth)acrylate, and cyclohexyl (meth)acrylate. In particular, mixtures of the (meth)acrylic acid alkyl esters are also suitable. Vinyl esters of carboxylic acids having 1 to 20 carbon atoms are, for example, vinyl laurate, vinyl stearate, vinyl propionate, Versatic acid vinyl esters, and vinyl acetate. Contemplated vinylaromatic compounds include vinyltoluene, alpha- and para-methylstyrene, alpha-butylstyrene, 4-n-butylstyrene, 4-n-decylstyrene and, preferably, styrene. The vinyl halides are ethylenically unsaturated compounds substituted by chlorine, fluorine or bromine, preferably vinyl chloride and vinylidene chloride. Examples of vinyl ethers include for example vinyl methyl ether or vinyl isobutyl ether. Preference is given to vinyl ethers of alcohols comprising 1 to 4 carbon atoms. Hydrocarbons having 4 to 8 carbon atoms and two olefinic double bonds include butadiene, isoprene and chloroprene. Preferred as monomers a) are the C1-to C10-alkyl acrylates and methacrylates, more particularly C1-to C₈-alkyl acrylates and methacrylates, and also styrene, and mixtures thereof. Very particular preference is given to methyl acrylate, methyl methacrylate, ethyl acrylate, n-butyl acrylate, n-butyl methacrylate, n-hexyl acrylate, octyl acrylate and 2-ethylhexyl acrylate, 2-propylheptyl acrylate, styrene and also mixtures of these monomers.

The monomers a) are preferably employed in an amount of at least 80% by weight based on the total amount of the monomers and are selected from the group consisting of C1-to C10-alkyl acrylates, C1-to C10-alkyl methacrylates, styrene and mixtures thereof. It is preferable when a styrene/(meth)acrylate copolymer is concerned, i.e. the monomers a) comprise both styrene and at least one (meth)acrylic acid alkyl ester monomer.

It is preferable to employ 80% to 90% by weight, based on the total amount of monomers, of at least one soft C2-to C20-alkyl (meth)acrylate monomer (al) which, when polymerized as a homopolymer, has a glass transition temperature of less than 0° C.

It is preferable to employ 1% to 15% by weight, based on the total amount of monomers, of at least one hard C1-to 20-alkyl (meth)acrylate monomer (a2) which, when polymerized as a homopolymer, has a glass transition temperature of more than 0° C.

It is preferable to employ 1% to 5% by weight of styrene.

Monomers b) The monomer mixture preferably comprises at least 0.1% by weight, in particular from 0.1% to 5% by weight or from 0.5% to 5% by weight, based on the total amount of monomers, of at least one ethylenically unsaturated monomer having at least one acid group (acid monomer). The acid monomers b) comprise not only monomers comprising at least one acid group but also anhydrides thereof and salts thereof. The monomers b) include alpha,beta-monoethylenically unsaturated monocarboxylic and dicarboxylic acids, half-esters of alpha,beta-monoethylenically unsaturated dicarboxylic acids, the anhydrides of the abovementioned alpha,beta-monoethylenically unsaturated carboxylic acids and also ethylenically unsaturated sulfonic acids, phosphonic acids or dihydrogenphosphates and water-soluble salts thereof, for example alkali metal salts thereof. Examples thereof are acrylic acid, methacrylic acid, itaconic acid, maleic acid, fumaric acid, crotonic acid, vinylacetic acid and vinyllactic acid. Examples of suitable ethylenically unsaturated sulfonic acids include vinylsulfonic acid, styrenesulfonic acid, acrylamidomethylpropanesulfonic acid, sulfopropyl acrylate and sulfopropyl methacrylate. Preferred monomers b) are alpha,beta-monoethylenically unsaturated C3-C8-carboxylic acids and C4-C8-dicarboxylic acids, for example itaconic acid, crotonic acid, vinylacetic acid, acrylamidoglycolic acid, acrylic acid and methacrylic acid and also anhydrides thereof. Particularly preferred monomers b) are itaconic acid, acrylic acid and methacrylic acid.

The acid groups of the monomer b) may be neutralized with suitable bases, for example with sodium hydroxide solution, potassium hydroxide solution, ammonia or organic amines, preferably tertiary amines, especially trialkylamines having preferably 1 to 4 carbon atoms in the alkyl group such as for example triethylamine.

Monomers c) The monomer mixture may optionally comprise at least one further monomer c) distinct from the monomers a) and b). The monomers c) may be employed in amounts for example of 0% to 10% by weight or of 0% to 5% by weight, in particular of 0.1% to 10% by weight or of 0.1% to 5% by weight or of 0.2% to 3% by weight based on the total amount of monomers.

Monomers c) are, for example, neutral and/or nonionic monomers having elevated solubility in water, for example the amides or the N-alkylolamides of the abovementioned carboxylic acids, for example acrylamide, methacrylamide, N-methylolacrylamide, N-methylolmethacrylamide or phenyloxyethyl glycol mono(meth)acrylate. Further monomers c) include, for example, hydroxyl-comprising monomers, in particular the hydroxyalkyl esters of the abovementioned alpha,beta-monoethylenically unsaturated carboxylic acids, preferably C₁-C₁₀-hydroxyalkyl (meth)acrylates, such as for example hydroxyethyl acrylate, hydroxyethyl methacrylate, hydroxypropyl acrylate or hydroxypropyl methacrylate, and also 4-hydroxybutyl acrylate. Further monomers c) include, for example, also amino-comprising monomers, in particular the aminoalkyl esters of the abovementioned alpha,beta-monoethylenically unsaturated carboxylic acids, preferably C₁-C₁₀-aminoalkyl (meth)acrylates, such as for example 2-aminoethyl (meth)acrylate or tert-butylaminoethyl methacrylate. Additionally contemplated as monomers c) are the nitriles of alpha,beta-monoethylenically unsaturated C3-C8-carboxylic acids, such as acrylonitrile or methacrylonitrile for example. Other suitable monomers c) are bifunctional monomers which as well as an ethylenically unsaturated double bond have at least one glycidyl group, oxazoline group, ureido group, ureido-analogous group or carbonyl group. Examples of glycidyl group-bearing monomers are ethylenically unsaturated glycidyl ethers and glycidyl esters, for example vinyl, allyl and methallyl glycidyl ethers, and glycidyl (meth)acrylate. Examples of carbonyl group-bearing monomers are the diacetonylamides of the abovementioned ethylenically unsaturated carboxylic acids, for example diacetone(meth)acrylamide, and the esters of acetylacetic acid with the abovementioned hydroxyalkyl esters of ethylenically unsaturated carboxylic acids, for example acetylacetoxyethyl (meth)acrylate. Examples of oxazoline group-bearing monomers c) are 2-vinyl-2-oxazoline and 2-isopropenyl-2-oxazoline. Examples of ureido group-bearing monomers c) are ureidoalkyl (meth)acrylates having 1 to 10 carbon atoms, preferably having 2 to 4 carbon atoms, in the alkyl group, in particular ureidoethyl methacrylate (UMA).

Examples of monomers c) further include crosslinking monomers having more than one free-radically polymerizable group, in particular two or more (meth)acrylate groups, for example butanediol di(meth)acrylate or allyl methacrylate.

Monomers c) also include those allowing postcrosslinking of the polymer, for example with polyfunctional amines, hydrazides, isocyanates or alcohols. Crosslinking is also possible through metal-salt crosslinking of the carboxyl groups using polyvalent metal cations, for example Zn or Al.

Suitable crosslinking may be accomplished, for example, by the polymer comprising keto groups or aldehyde groups (preferably 0.0001 to 1 mol, or 0.0002 to 0.10 mol, or 0.0006 to 0.03 mol) and the polymer dispersion additionally comprising a compound having at least 2 functional groups, in particular 2 to 5 functional groups, which enter into a crosslinking reaction with the keto or aldehyde groups. The keto or aldehyde groups may be bonded to the polymer through copolymerization of suitable monomers c). Suitable monomers c) are, for example, acrolein, methacrolein, vinyl alkyl ketones having 1 to 20, preferably 1 to 10, carbon atoms in the alkyl radical, formylstyrene, (meth)acrylic acid alkyl esters having one or two keto or aldehyde groups, or one aldehyde group and one keto group, in the alkyl radical, the alkyl radical preferably comprising a total of 3 to 10 carbon atoms, e.g.

(meth)acryloyloxyalkylpropanals. N-oxoalkyl(meth)acrylamides are moreover also suitable. Particularly preferred are acetoacetyl(meth)acrylate, acetoacetoxyethyl(meth)acrylate and especially diacetoneacrylamide. Compounds capable of undergoing a crosslinking reaction with the keto or aldehyde groups are for example compounds having hydrazide, hydroxylamine, oxime ether or amino groups. Suitable compounds having hydrazide groups are for example polycarboxylic acid hydrazides having a molar weight of up to 500 g/mol. Preferred hydrazide compounds are dicarboxylic dihydrazides having preferably 2 to 10 carbon atoms. Examples include oxalic dihydrazide, malonic dihydrazide, succinic dihydrazide, glutaric dihydrazide, adipic dihydrazide, sebacic dihydrazide, maleic dihydrazide, fumaric dihydrazide, itaconic dihydrazide and/or isophthalic dihydrazide. Particular preference is given to adipic dihydrazide, sebacic dihydrazide and isophthalic dihydrazide. Examples of suitable compounds having amino groups are ethylenediamine, propylenediamine, tetramethylenediamine, pentamethylenediamine, hexamethylenediamine, diethylenetriamine, triethylenetetramine, polyethyleneimines, partly hydrolyzed polyvinylformamides, ethylene oxide and propylene oxide adducts such as the “Jeffamines”, cyclohexanediamine and xylylenediamine. The compound having the functional groups may be added to the composition or to the dispersion of the polymer at any point in time. In the aqueous dispersion there is not yet any crosslinking with the keto or aldehyde groups. Crosslinking occurs on the coated substrate only in the course of drying. The amount of the compound having the functional groups is preferably measured such that the molar ratio of the functional groups to the keto and/or aldehyde groups of the polymer is 1:10 to 10:1, especially 1: 5to 5: 1,particularly preferably 1:2 to 2:1 and very particularly preferably 1:1.3 to 1.3:1. Especially preferred are equimolar amounts of the functional groups and of the keto and/or aldehyde groups.

A particularly preferred polymer is produced from a1) 80% to 90% by weight, based on the total amount of monomers, of at least one soft C2-to C20-alkyl (meth)acrylate monomer which, when polymerized as a homopolymer, has a glass transition temperature of less than 0° C.

a2) 1% to 15% by weight, based on the total amount of monomers, of at least one hard C1-to C20-alkyl (meth)acrylate monomer which, when polymerized as a homopolymer, has a glass transition temperature of more than 0° C.

a3) 1% to 5% by weight of styrene,

b) 0.1% to 5% by weight, based on the total amount of monomers, of at least one monomer having at least one acid group; and

c) optionally at least one further monomer distinct from the monomers a) and b).

The glass transition temperature of the polymer is preferably not more than 15° C. For applications as a pressure-sensitive adhesive the glass transition temperature of the polymer is preferably not more than 0° C., particularly preferably −60° C. to 0° C. or −60° C. to −10° C. and very particularly preferably −55° C. to −20° C. For applications as a laminating adhesive the glass transition temperature of the polymer is preferably more than −20° C., for example from −15° C. to +15° C.

Through targeted variation of monomer type and quantity, those skilled in the art are able according to the invention to produce aqueous polymer compositions whose polymers have a glass transition temperature in the desired range. Orientation is possible using the Fox equation. According to Fox (T. G. Fox, Bull. Am. Phys. Soc. 1956 [Ser. II] 1, page 123 and according to Ullmann's Encyclopedia of Industrial Chemistry, vol. 19, page 18, 4th edition, Verlag Chemie, Weinheim, 1980), the glass transition temperature of copolymers is given to a good approximation by:

1/T_{g}=x¹/T_{g}1+x²/T_{g}²+. . . x_{g}ⁿ/T_{g}n,

wherein x¹, x², . . . xₙ are the mass fractions of the monomers 1, 2, . . . n and T_{g}¹, T_{g}², . . . T_{g}ⁿ are the glass transition temperatures in degrees Kelvin of the polymers constructed from only one of the monomers 1, 2, . . . n at a time. The T_{g} values for the homopolymers of the majority of monomers are known and are listed for example in Ullmann's Encyclopedia of Industrial Chemistry, vol. 5, vol. A21, page 169, VCH Weinheim, 1992; further sources for glass transition temperatures of homopolymers are, for example, J. Brandrup, E. H. Immergut, Polymer Handbook, 1^{st} Ed., J. Wiley, New York 1966, 2^{nd} Ed. J. Wiley, New York 1975, and 3^{rd} Ed. J. Wiley, New York 1989.

The polymer dispersions are obtainable by free-radical emulsion polymerization of ethylenically unsaturated compounds (monomers). This polymerization is preferably carried out in emulsifier-free or low-emulsifier fashion in the sense that less than 0.8, preferably not more than 0.5, parts by weight of emulsifier, based on 100 parts by weight of monomers, are added to stabilize the polymer dispersion according to the invention. Emulsifiers are nonpolymeric, amphiphilic, surface-active substances that are added to the polymerization mixture before or after the polymerization. Small amounts of emulsifiers, originating for example from the use of emulsifier-stabilized polymer seed, are harmless here. It is preferable to employ altogether less than 0.3 parts by weight or less than 0.2 parts by weight of emulsifier, for example from 0.05 to 0.8 parts by weight or from 0.05 to 0.5 parts by weight or from 0.05 to 0.3 parts by weight, based on 100 parts by weight of monomers or no emulsifier.

The polymerization may employ at least one chain transfer agent. This makes it possible to reduce the molar mass of the emulsion polymer through a chain termination reaction. The chain transfer agents are bonded to the polymer in this procedure, generally to the chain end. The amount of the chain transfer agents is especially 0.05 to 4 parts by weight, particularly preferably 0.05 to 0.8 parts by weight and very particularly preferably 0.1 to 0.6 parts by weight, based on 100 parts by weight of the monomers to be polymerized. Suitable chain transfer agents are, for example, compounds having a thiol group such as tert-butyl mercaptan, thioglycolic acid ethylhexyl ester, mercaptoethanol, mercaptopropyltrimethoxysilane or tert-dodecyl mercaptan. The chain transfer agents are generally compounds of low molecular mass, having a molar weight of less than 2000, in particular less than 1000 g/mol. Preferred are 2-ethylhexyl thioglycolate (EHTG), isooctyl 3-mercaptopropionate (IOMPA) and tert-dodecyl mercaptan (tDMK).

The polymerization may be carried out with seed control, i.e. in the presence of polymer seed (seed latex). Seed latex is an aqueous dispersion of finely divided polymer particles having an average particle diameter of preferably 20 to 40 nm. Seed latex is used in an amount of preferably 0.01 to 0.5 parts by weight, particularly preferably of 0.03 to 0.3 parts by weight, or of 0.03 to not more than 0.1 parts by weight based on 100 parts by weight of monomers. A latex based on polystyrene or based on polymethyl methacrylate is suitable for example. One preferred seed latex is polystyrene seed.

The polymer dispersion may be produced by emulsion polymerization. Emulsion polymerization comprises polymerizing ethylenically unsaturated compounds (monomers) in water using typically ionic and/or nonionic emulsifiers and/or protective colloids or stabilizers as surface-active compounds to stabilize the monomer droplets and the polymer particles subsequently formed from the monomers. However, the polymerization is preferably carried out in low-emulsifier fashion and preferably without addition or formation of protective colloids.

Stabilization of the resulting polymer dispersion may be effected via a special operating mode, for example with a slow initial monomer feed in the presence of a very small amount of polymer seed (seed control) followed by neutralization of employed acid monomers in the course of the polymerization.

The emulsion polymerization may be initiated using water-soluble initiators. Water-soluble initiators are for example ammonium salts and alkali metal salts of peroxodisulfuric acid, for example sodium peroxodisulfate, hydrogen peroxide or organic peroxides, for example tert-butyl hydroperoxide. Also suitable as initiators are so-called reduction-oxidation (redox) initiator systems. Redox initiator systems consist of at least one generally inorganic reducing agent and an inorganic or organic oxidizing agent. The oxidizing component is, for example, selected from the emulsion polymerization initiators already mentioned hereinabove. The reducing component is, for example, selected from alkali metal salts of sulfurous acid, for example sodium sulfite, sodium hydrogensulfite, alkali metal salts of disulfurous acid such as sodium disulfite, bisulfite addition compounds of aliphatic aldehydes and ketones, such as acetone bisulfite or reducing agents such as hydroxymethanesulfinic acid and the salts thereof, or ascorbic acid. The redox initiator systems may be employed with co-use of soluble metal compounds whose metallic component may appear in a plurality of valence states. Typical redox initiator systems are, for example, ascorbic acid/iron(II) sulfate/sodium peroxydisulfate, tert-butyl hydroperoxide/sodium disulfite, tert-butyl hydroperoxide/sodium hydroxymethanesulfinic acid. The individual components, for example the reducing component, may also be mixtures, for example a mixture of the sodium salt of hydroxymethanesulfinic acid and sodium disulfite.

The recited initiators are generally employed in the form of aqueous solutions, the lower concentration limit being determined by the amount of water acceptable in the dispersion and the upper concentration limit being determined by the solubility in water of the particular compound. The concentration of the initiators is generally from 0.1% to 30% by weight, preferably 0.5% to 20% by weight, particularly preferably 1.0% to 10% by weight, based on the monomers to be polymerized. It is also possible to use two or more different initiators in the emulsion polymerization.

The emulsion polymerization is generally carried out at 30° C. to 130° C., preferably at 50° C. to 90° C. The polymerization medium may consist either solely of water or of mixtures of water and liquids miscible therein such as methanol. Preference is given to using solely water. In the polymerization a polymer seed may be initially charged for more effective adjustment of particle size.

The manner in which the initiator is added to the polymerization vessel over the course of the free-radical aqueous emulsion polymerization is known to those of ordinary skill in the art. It may be either initially charged to the polymerization vessel in its entirety or employed continuously or in a staged manner at the rate of its consumption over the course of the free-radical aqueous emulsion polymerization. This specifically depends on the chemical nature of the initiator system and on the polymerization temperature. Preference is given to initially charging a portion and supplying the remainder to the polymerization zone at the rate of its consumption. In order to remove the residual monomers, it is common after the end of the emulsion polymerization proper, i.e. after a monomer conversion of at least 95%, to add initiator as well. In the feed process, the individual components may be added to the reactor from above, from the side or from below through the reactor floor. The emulsion polymerization generally affords aqueous dispersions of the polymer having solids contents of from 15% to 75% by weight, preferably from 40% to 60% by weight, particularly preferably not less than 50% by weight.

The pH of the polymer dispersion is preferably adjusted to a pH greater than 5, more particularly to a pH of between 5.5 and 8.

The polymer dispersions according to the invention may be used in aqueous adhesive preparations, for example as a pressure-sensitive adhesive or for production of laminates, i.e. in aqueous laminating adhesive preparations for bonding large-surface-area substrates, especially for producing composite films.

The present invention therefore also provides for the use of the polymer dispersions described herein as an adhesive, for example as a pressure-sensitive adhesive or as a laminating adhesive, in particular as a laminating adhesive, for example for producing composite films.

The present invention also provides composite films produced from a first and at least a second polymer film which are bonded to one another using an adhesive comprising the aqueous polymer dispersion according to the invention described herein.

Due to the optically advantageous coating patterns the polymer dispersions are particularly suitable for producing transparent products, for example composite films where at least one of the polymer films is transparent or the entire composite film is transparent.

The present invention further relates to a method for producing composite films, wherein an aqueous polymer dispersion described herein is provided and at least two films are bonded to one another using the aqueous polymer dispersion. The aqueous polymer dispersions may here be employed as such or after formulation with customary further auxiliaries. Customary auxiliaries are for example crosslinkers, thickeners, light stabilizers, biocides etc.

In the method for producing composite films, at least two films are bonded to one another using the aqueous polymer dispersion. In this method, the polymer dispersion of the invention, or a preparation formulated accordingly, is applied to the large-surface-area substrates to be bonded, preferably with a layer thickness of 0.1 to 20 g/m², more preferably 1 to 7 g/m², by means, for example, of knife coating, spreading, etc. Customary coating techniques may be employed, for example roller coating, reverse roller coating, gravure roller coating, reverse gravure roller coating, brush coating, rod coating, spray coating, airbrush coating, meniscus coating, curtain coating or dip coating. After a short time for evaporation of the dispersion water (preferably after 1 to 60 seconds) the coated substrate may then be laminated with a second substrate, wherein the temperature may be for example 20° C. to 200° C., preferably 20° C. to 100° C., and the pressure may be for example 100 to 3000 kN/m², preferably 300 to 2000 kN/m2. The polymer dispersion according to the invention may be employed as a one-component composition, i.e. without additional crosslinking agents, in particular without isocyanate crosslinkers. However, the polymer dispersion according to the invention may also be used as a two-component adhesive, in which case a crosslinking component is added, such as a water-emulsifiable isocyanate for example. At least one of the films may be metallized or printed on the side coated with the adhesive. Suitable substrates include for example polymer films, especially made of polyethylene (PE), oriented polypropylene (OPP), unoriented polypropylene (CPP), polyamide (PA), polyethylene terephthalate (PET), polyacetate, cellophane, polymer films coated (vapor coated) with metal, for example aluminum, (metallized films for short) or metal foils, for example made of aluminum. The recited films may be bonded to one another or to a film of another type, for example polymer films to metal foils, different polymer films to one another etc. The recited films may also have been printed with printing inks for example.

One embodiment of the invention is a composite film produced using one of the above-described aqueous polymer dispersions according to the invention, wherein the material of a first film is selected from OPP, CPP, PE, PET and PA and wherein the material of a second film is selected from OPP, CPP, PE, PET, PA and metal foil. In one embodiment of the invention the first film and/or the second film has been printed or metallized on the respective side which is coated with the polymer dispersion according to the invention. The thickness of the substrate films may be for example from 5 to 100 μm, preferably from 5 to 40 μm.

Surface treatment of the film substrates before coating with a polymer dispersion according to the invention is not absolutely necessary. However, better results can be obtained if the surfaces of the film substrates are modified prior to coating. Customary surface treatments may be employed to amplify the adhesive effect, for example corona treatment. The corona treatment or other surface treatments are carried out to the extent required for sufficient wettability with the coating composition. Customarily, corona treatment of approximately 10 watts per square meter per minute is sufficient for this purpose. Alternatively or in addition it is optionally also possible to use primers or tie coats between film substrate and adhesive coating. Other additional functional layers may also be present on the composite films, examples being barrier layers, printed layers, paint layers or lacquer layers, or protective layers. These functional layers may be located externally, i.e. on the side of the film substrate facing away from the adhesive-coated side, or internally, between film substrate and adhesive layer. Particular advantages of the products according to the invention are in particular:
excellent coating patterns without optical film interference of coated films and without adverse effects on the bonding result
good defoaming and good wetting of film substrates

The di- or monoalkyl sulfosuccinate (B) and the ethylene oxide/propylene oxide block copolymer (C) are preferably premixed before addition to the aqueous polymer dispersion. This makes it possible to avoid gelling at the dropping point such as may otherwise occur during addition of di- or monoalkyl sulfosuccinate to aqueous polymer dispersions.

### Examples

Abbreviations and input materials

EO ethylene oxide unit (—CH2CH2O—)

PO propylene oxide unit (—CH(CH3)CH2O—)

1) Defoamer

| | | |
|---|---|---|
| Foamaster ® MO | Mineral oil based | |
| Foamaster ® NO | Based on natural oils (fatty acid esters), for | >90% renewable raw |
| | example soybean oil, rapeseed oil, | materials, free from |
| | sunflower oil | mineral oils and silicone |
| | | oils |
| Foamaster ® WO | White oil with hydrophobic particles | Pharma grade, |
| | | Foodstuffs approved |
| FoamStar ® SI | Silicone oil based | |
| FoamStar ® PB | Polymer based | |
| FoamStar ® ED | Polymer emulsion | |
| FoamStar ® ST | Polymer based, | |
| | mineral oil and/or polysiloxane carrier | |

| | |
|---|---|
| Foamaster ® WO 2310 | Composition based on white oil and paraffin wax |
| Foamaster ® WO 2323 | Composition based on white oil and hydrophobized silica particles |
| Foamaster ® NO 2306 | Composition based on natural fatty acid ester oils and anionic and |
| | nonionic surfactants |
| Foamaster ® NO 2331 | Preparation based on glycerides, C16-18- and C18-unsaturated |
| | hydrophobic components and nonionic surfactants |
| FoamStar ® ED 2522 | Aqueous emulsion of modified polydimethylsiloxane |
| Foamaster ® ED 2523 | Aqueous emulsion based on polyalkoxylate, modified silicones and |
| | fatty acid esters |
| FoamStar ® SI 2213 | Modified polydimethylsiloxane |
| FoamStar ® ST 2438 | Modified polydimethylsiloxane with hyper-branched star polymer |
| FoamStar ® PB 2724 | Modified polyalkylene glycol |
| Tego ® Antifoam 2291 | Preparation based on mineral oil, free from hydrophobic particles |
| Tego ® Antifoam 4-94 | Aqueous emulsion of a polyether siloxane |

2) Dialkyl or monoalkyl sulfosuccinates

Dodecyl sulfosuccinate, sodium salt (dialkyl sulfosuccinate)

Diisooctyl sulfosuccinate

| | |
|---|---|
| Disponil ® SUS IC 10 | Diisodecyl sulfosuccinate, sodium salt |
| Hydropalat ® WE 3475 | Di-2-ethylhexyl sulfosuccinate, sodium salt |
| Hydropalat ® WE 3488 | Sodium 1,4-diisodecylsulfonatosuccinate |
| Lumiten ® I-SC | Di-2-ethylhexyl sulfosuccinate, sodium salt |

3) Alkoxylated nonionic additives Hydropalat® WE 3161, 3162, 3164, 3966 Ethylene oxide/propylene oxide block copolymers

| | | Ethylene | Molar | |
|---|---|---|---|---|
| | Molar weight | oxide | weight | |
| | Polypropylene | proportion | (from OH | Surface |
| Hydropalat ® | block | % by wt. | number) | tension¹⁾ |
| WE 3161 | 1750 | 10 | 2000 | 40 mN/m |
| WE 3162 | 1750 | 20 | 2450 | 41 mN/m |
| WE 3164 | 1750 | 40 | 2900 | 41 mN/m |

¹⁾DIN 53914, 1 g/l in water, 23° C.

| | |
|---|---|
| Hydropalat ® WE 3120 | alkoxylated C12-14-fatty alcohol + 5 EO + |
| | 4 PO |
| Hydropalat ® WE 3130 | alkoxylated C10-14-fatty alcohol + 3 EO |
| Hydropalat ® WE 3197 | ethoxylated C9-11-fatty alcohol |

4) Adhesive Polymers

Polymer A:

Polymer A is produced by emulsion polymerization from

86.1 parts by wt. n-butyl acrylate

8.9 parts by wt. methyl acrylate

2 parts by wt. styrene

2 parts by wt. methacrylic acid

1 part by wt. itaconic acid

0.1 parts by wt. polystyrene seed

0.06 parts by wt. 2-ethylhexyl thioglycolate (molecular weight regulator)

Neutralized with ammonia; film surface energy: 23 mN/m; <1% emulsifier

Epotal® FLX 3628: Aqueous dispersion of a copolymer based on acrylate esters and methacrylate esters

Test methods

Free surface energy

Measuring Instrument: Drop Shape Analyzer-DSA 100 (Krüss)

The following reference liquids were employed (surface tension reported in mN/m):

| | Yₗ | Yₗ^{d} | Yₗ^{p} |
|---|---|---|---|
| Deionized | 72.8 | 21.8 | 51 |
| water | | | |
| Formamide | 58.0 | 39.0 | 19.0 |
| Diiodomethane | 50.8 | 50.8 | 0 |

A 350 μm doctor blade is used to produce films of the polymer dispersions on a PET film and the contact angles to the three reference liquids are measured at 23° C.

The free surface energy is determined from the measured contact angles using the

Owens-Wendt method (see for example Jorda-Vilaplana et al, J. Appl. Sci. 2015, DOI:

10.1002/APP.42391; Owens et al, J. Appl. Polym. Sci. 1969, 13, 1741):

γ₁ (1+cosθ)=2 (γₛ^{d}γ₁^{d})^{1/2}+2 (γₛ^{p}γ₁^{p})^{1/2}

θ Contact angle between the reference liquid and the dried film of the dispersion

γ₁ Free surface energy of the reference liquid; y₁=γ₁^{d}+γ₁^{p}

γ₁^{d} Disperse proportion of free surface energy of the reference liquid

γ₁^{p}Polar proportion of free surface energy of the reference liquid

γₛd Disperse proportion of free surface energy of the solid surface to be tested

γₛ^{P} Polar proportion of free surface energy of the solid surface to be tested

γₛFree surface energy of the solid surface to be tested; γₛ=γₛd+γₛ^{P}

Plotting γ₁(1+cosθ)/2 (yₗ^{d})^{1/2} against (γ₁^{d})1/2 /(y₁^{d})^{1/2} results in a regression line having the gradient (γₛ^{P})^{1/2} and the point of intersection with the Y-axis at (γₛ^{d})^{1/2.} This makes it possible to calculate the free surface energy: γₛ^{p}) γₛ=γₛ^{d}+γₛ^{P}.

Foaming test

100 ml vials are filled with 35 ml of dispersion and diluted with 10 ml of distilled water. The defoamers and wetting agents are then added and the vials closed with their lid.

The test is performed in a Scandex shaker. For comparative measurements 16 samples are arranged on a shaker plate and shaken at 100 Hz for 10 min. At the end of the test, markings are made for the liquid phase and for the phase with micro and macro foam. Photos are taken at intervals of 1, 5 and 10 minutes for evaluation. The ratio of micro to macro foam is determined after 5 min and is considered to be constant during foam reduction.

The result is reported in % incorporated air.

Calculation example: % air=t(tr)−t(1) *100/t)

t(tr)=dispersion height in shaker jar at reference time tr in mm

t(l)=dispersion height in shaker jar at start time in mm

Visual assessment of film (degree of wetting)

The dispersion film is visually assessed with regard to structure formation a) after 24 hours and b) after 28 days after addition of the composition to be tested

Assessment is carried out according to the following criteria:

4 marked wetting defects

3 few wetting defects

2 unsettled structure of the film, difficult to decide whether wetting defects already present or still homogenous film

1 very good, no wetting defects

### EXAMPLES 1 to 11

### Comparative Experiments

The aqueous polymer dispersion of polymer A was mixed with various amounts of different defoamers and the degree of wetting was investigated.

TABLE 1
Effect of defoamers on degree of wetting

| No. | Defoamer | Amount of defoamer | Wetting |
|---|---|---|---|
| 1 | — | 0% | 1 |
| 2 | Foamaster ® NO 2306 | 0.2% | 2 |
| 3 | Foamaster ® NO 2331 | 0.2% | 2 |
| 4 | Foamaster ® WO 2323 | 0.2% | 3 |
| 5 | Foamaster ® WO 2310 | 0.2% | 4 |
| 6 | Foamaster ® ED 2522 | 0.1% | 3 |
| 7 | Foamaster ® ED 2523 | 0.1% | 2 |
| 8 | Foamaster ® SI 2213 | 0.1% | 4 |
| | (comprises silicone oil) | | |
| 9 | Foamaster ® ST 2438 | 0.1% | 4 |
| | (comprises silicone oil) | | |
| 10 | Tego ® Antifoam 2291 | 0.2% | 2 |
| | (paraffin oil) | | |
| 11 | Tego ® Antifoam 4-94 | 0.1% | 4 |
| | (polyether siloxane) | | |

Table 1 shows that an addition of silicone defoamers can result in highly structured dispersion films having marked wetting defects (table 1, examples 8, 9, 11). Defoamers based on white oils can also cause wetting defects when used without further measures (see table 1, experiments 4 and 5).

### EXAMPLES 12 to 23

### Comparative Experiments

The aqueous polymer dispersion of polymer A was mixed with various defoamers and wetting agents and the degree of wetting and the foaming behavior were investigated.

TABLE 2
Effect of defoamers and anionic wetting
agents on degree of wetting

| | | 0.2% | | | | | |
|---|---|---|---|---|---|---|---|
| | | anionic | | | | | |
| | 0.2% | wetting | | Foam | Foam | Foam | Foam |
| No. | defoamer | agent | Wetting | 1 min | 5 min | 10 min | Sum |
| 12 | — | WE 3475 | 1 | 250 | 200 | 200 | 650 |
| 13 | NO 2331 | WE 3475 | 2 | 50 | 30 | 10 | 90 |
| 14 | WO 2310 | WE 3475 | 2 | 40 | 20 | 0 | 60 |
| 15 | Tego AF 4- | WE 3475 | 4 | 60 | 30 | 20 | 110 |
| | 94 | | | | | | |
| 16 | SI 2213 | WE 3475 | 4 | 200 | 200 | 200 | 600 |
| 17 | PB 2724 | WE 3475 | 1 | 300 | 250 | 250 | 800 |
| 18 | without | SUS IC 10 | 1 | 200 | 150 | 50 | 400 |
| 19 | NO 2331 | SUS IC 10 | 2 | 30 | 20 | 10 | 60 |
| 20 | WO 2310 | SUS IC 10 | 2 | 20 | 10 | 0 | 30 |
| 21 | Tego AF 4- | SUS IC 10 | 3 | 30 | 10 | 0 | 40 |
| | 94 | | | | | | |
| 22 | SI 2213 | SUS IC 10 | 3 | 200 | 150 | 150 | 500 |
| 23 | PB 2724 | SUS IC 10 | 1 | 300 | 250 | 250 | 800 |

Table 2 shows that in direct comparison sulfosuccinates having relatively long fatty acid ester chains (SUS IC 10) in each case exhibit less foaming than sulfosuccinates having relatively short fatty acid ester chains (WE 3475) in defoamer-comprising aqueous polymer dispersions, i.e. the defoamer is better emulsified.

### EXAMPLES 23 to 31

The aqueous polymer dispersion of polymer A was mixed with various defoamers and wetting agents and the degree of wetting and the foaming behavior were investigated.

TABLE 3
Effect of defoamers on degree of wetting

| | | 0.2% | 0.1% | | | | | |
|---|---|---|---|---|---|---|---|---|
| | | anionic | nonionic | | | | | |
| | 0.2% | wetting | wetting | | Foam | Foam | Foam | Foam |
| No. | defoamer | agent | agent | Wetting | 1 min | 5 min | 10 min | Sum |
| 23*⁾ | — | — | — | | 80 | 50 | 40 | 170 |
| 24*⁾ | WO2310 | WE 3475 | WE 3130 | 2 | 50 | 10 | 5 | 65 |
| 25*⁾ | WO2310 | WE 3475 | WE 3162 | 1 | 30 | 20 | 10 | 60 |
| 26 | WO2310 | SUS IC 10 | WE 3130 | 2 | 10 | 5 | 5 | 20 |
| 27a | WO2310 | SUS IC 10 | WE 3162 | 1 | 5 | 5 | 5 | 15 |
| 27b | WO2310 | SUS IC 10 | WE 3162 | 1 | 10 | 10 | 0 | 20 |
| 28*⁾ | PB 2724 | WE 3475 | WE 3130 | 2 | 400 | 400 | 350 | 1150 |
| 29*⁾ | PB 2724 | WE 3475 | WE 3162 | 1 | 400 | 400 | 350 | 1150 |
| 30*⁾ | PB 2724 | SUS IC 10 | WE 3130 | 2 | 350 | 300 | 300 | 950 |
| 31*⁾ | PB 2724 | SUS IC 10 | WE 3162 | 1 | 300 | 300 | 300 | 900 |

*⁾comparative

Table 3 shows that sulfosuccinates having relatively short fatty acid ester chains (WE 3475) in combination with strongly hydrophobic white oil/wax defoamers (Foamaster® WO 2310) exhibit more severe foaming in aqueous polymer dispersions than sulfosuccinates having relatively long fatty acid ester chains (SUS IC 10).

### EXAMPLES 32 to 34

To compare the defoaming effect of silicone oil with white oil, aqueous polymer dispersions were admixed with defoamers based on white oil and based on silicone oil and also with wetting agents, and the short- and long-term foaming behavior was investigated.

TABLE 4.1
Composition of examples 32 to 34

| No. | Polymer | ED 2522 | WO2310 | SUS IC 10 | WE3120 | WE3475 |
|---|---|---|---|---|---|---|
| 32*⁾ | Polymer A | | — | | | |
| 33*⁾ | Epotal ® FLX 3628 | 0.1% | — | 0.1% | 0.1% | 0.1% |
| 34 | Epotal ® FLX 3628 | | 0.1% | 0.1% | 0.1% | 0.1% |

*⁾comparative

TABLE 4.2
Foaming behavior of examples 32 to 34

| | After 1 day 23° C. | | | | After 14 days at 40° C. storage | | | |
|---|---|---|---|---|---|---|---|---|
| | | | Foam | | | | Foam | |
| | Foam | Foam | 10 | Foam | Foam | Foam | 10 | Foam |
| No. | 1 min | 5 min | min | Sum | 1 min ¹⁾ | 5 min ¹⁾ | min ¹⁾ | Sum ¹⁾ |
| 32*⁾ | 200 | 100 | 100 | 400 | 200 | 200 | 190 | 590 |
| 33*⁾ | 150 | 90 | 90 | 330 | 200 | 200 | 190 | 590 |
| 34 | 10 | 10 | 10 | 30 | 30 | 20 | 10 | 60 |

*⁾comparative;
¹⁾ defoaming effect after 14 days warm storage at 40° C.

### EXAMPLES 35-41

The aqueous polymer dispersion of polymer A was mixed with defoamers and wetting agents and the degree of wetting and the foaming behavior were investigated.

TABLE 5.1
Compositions of polymer dispersions; reported amounts in parts by weight

| | Polymer | Foamaster ® | Na dodecyl | Additive | |
|---|---|---|---|---|---|
| No. | dispersion | WO 2310 | sulfosuccinate | Hydropalat ® . . . | Wetting |
| 35 *⁾ | 100 Polymer A | 0 | 0 | 0 | 4 |
| 36 *⁾ | 100 Polymer A | 0.1 | 0.2 | 0.1 WE 3120 | 4 |
| 37 *⁾ | 100 Polymer A | 0.1 | 0.2 | 0.1 WE 3130 | 4 |
| 38 | 100 Polymer A | 0.1 | 0.2 | 0.1 WE 3161 | 2 |
| 39 | 100 Polymer A | 0.1 | 0.2 | 0.1 WE 3162 | 1 |
| 40 | 100 Polymer A | 0.1 | 0.2 | 0.1 WE 3164 | 1 |
| 41 *⁾ | 100 Polymer A | 0.1 | 0.2 | 0.1 WE 3197 | 3 |

*⁾ comparative

TABLE 5.2
Foaming test results; reported as % incorporated air

| No. | After 1 min | After 5 min | After 10 min | Sum |
|---|---|---|---|---|
| 35 *⁾ | 200 | 200 | 200 | 600 |
| 36 *⁾ | 190 | 190 | 150 | 530 |
| 37 *⁾ | 180 | 180 | 150 | 510 |
| 38 | 150 | 150 | 130 | 430 |
| 39 | 150 | 150 | 140 | 440 |
| 40 | 150 | 150 | 150 | 450 |
| 41 *⁾ | 200 | 190 | 180 | 570 |

*⁾ comparative

TABLE 5.3
Foaming test results after 1 week storage
at 40° C.; Reported as % incorporated air

| No. | After 1 min | After 5 min | After 10 min | Sum |
|---|---|---|---|---|
| 35 *⁾ | 200 | 200 | 150 | 550 |
| 36 *⁾ | 200 | 150 | 120 | 470 |
| 37 *⁾ | 150 | 100 | 100 | 350 |
| 38 | 150 | 120 | 90 | 360 |
| 39 | 180 | 150 | 100 | 430 |
| 40 | 200 | 200 | 120 | 520 |
| 41 *⁾ | 200 | 300 | 150 | 650 |

*⁾ comparative

### EXAMPLE 42

When adding Hydropalat® WE 3488 (dialkyl sulfosuccinate) and Hydropalat® WE 3162 (ethylene oxide/propylene oxide block copolymer) it has proven particularly advantageous to premix these two wetting additives before adding them to the polymer dispersion. This makes it possible to avoid gelling at the dropping point such as may otherwise occur during addition of dialkyl sulfosuccinates. The gelation behavior for various additives and combinations is reported in table 6 below.

TABLE 6
Gelation behavior

| | 20% aqueous | 40% aqueous | 60% aqueous | 80% aqueous |
|---|---|---|---|---|
| | solution | solution | solution | solution |
| Lumiten ® I-SC | Cloudy/trapped | Gelled mass/ | Gelled mass/ | Clear/with |
| (sulfosuccinate | air bubbles | trapped air | trapped air | trapped air |
| type) | | bubbles/not | bubbles/not | bubbles |
| | | flowable | flowable | |
| Hydropalat ® WE | Cloudy/without | Viscous/ | Viscous/ | Slightly cloudy/ |
| 3488 | trapped air | trapped air | trapped air | without air |
| | bubbles | bubbles | bubbles | bubbles |
| Hydropalat ® WE | Readily mobile, | Readily mobile, | Readily mobile, | Readily mobile, |
| 3488/ | clear liquid | clear liquid | clear liquid | clear liquid |
| Hydropalat ® | | | | |
| 3162 (1:1) | | | | |
| premixture | | | | |

1. A composition, comprising:
(A) a defoamer mixture comprising (i) an oil selected from the group consisting of an aromatics-free white oil, a natural fatty acid oil, and mixtures thereof and (ii) hydrophobic particles;
(B) a di- or monoalkyl sulfosuccinate, wherein each alkyl group independently has at least 9 carbon atoms; and
(C) an ethylene oxide/propylene oxide block copolymer having a molecular weight of 1000 to 3000 and an ethylene oxide proportion of 10% to 40% by weight based on the block copolymer.

2. The composition of claim 1, wherein the oil is the aromatics-free white oil.

3. The composition of claim 1, wherein the hydrophobic particles are wax particles selected from the group consisting of a distearyl ethylenediamide, a paraffin wax, an ester wax, a fatty alcohol wax, waxes and a fatty acid amide amides, and mixtures thereof.

4. The composition of claim 1, wherein each alkyl group of the di- or monoalkyl sulfosuccinate independently has 10 to 20 carbon atoms.

5. The composition of claim 1, wherein the ethylene oxide/propylene oxide block copolymer has:
a surface tension of at least 40 mN/m, measured in solution in distilled water at 23° C. and at a concentration of 1 g/1 according to DIN EN 14370:2004-11; and/or a cloud point of above 23° C., measured according to DIN EN 1890:2006.

6. The composition of claim 1, comprising:
0.8 to 1.2 parts by weight of the defoamer mixture (A);
1.6 to 2.4 parts by weight of the at least one di- or monoalkyl sulfosuccinate (B), and
0.8 to 1.2 parts by weight of the at least one ethylene oxide/propylene oxide block copolymer (C).

7. A method of producing a formulation, the method comprising adding the composition of claim 1 to an aqueous dispersion of a hydrophobic polymer having a free surface energy of less than 35 mN/m.

8. An aqueous polymer dispersion, comprising,
(i) the composition of claim 1; and
(ii) a hydrophobic polymer dispersed in an aqueous phase and having a free surface energy of less than 35 mN/m.

9. The aqueous polymer dispersion of claim 8, which comprises less than 1% by weight of emulsifiers that are distinct from the di- or monoalkyl sulfosuccinate (B) and the ethylene oxide/propylene oxide block copolymer (C) and that have a surface tension of less than 25 mN/m.

10. The aqueous polymer dispersion of claim 8, wherein a glass transition temperature of the hydrophobic polymer is at most 15° C. measured by differential scanning calorimetry according to ASTM D 3418-08 at a heating rate of 20° C./min.

11. The aqueous polymer dispersion of claim 8, wherein the hydrophobic polymer is produced from
a) at least 60% by weight, based on a total amount of monomers, of at least one monomer selected from the group consisting of a C1 to C20-alkyl acrylate, a C1 -to C20-alkyl methacrylate, a vinyl ester of a carboxylic acid comprising up to 20 carbon atoms, a vinylaromatic comprising up to 20 carbon atoms, a vinyl halide, a vinyl ether of an alcohol comprising 1 to 10 carbon atoms, an aliphatic hydrocarbon comprising hydrocarbons having 2 to 8 carbon atoms and one or two double bonds, and mixtures thereof,
b) at least 0.1 wt %, based on the total amount of monomers, of at least one monomer having at least one acid group; and
c) optionally at least one further monomer distinct from the at least one monomer a) and the at least one monomer b).

12. The aqueous polymer dispersion of claim 11, wherein the at least one monomer a) is employed in an amount of at least 80% by weight, based on the total amount of monomers. and is selected from the group consisting of a C1-to C10-alkyl acrylate, a C1-to C10-alkyl methacrylate, styrene, and mixtures thereof; and
the at least one monomer b) is employed in an amount of 0.5% to 5% by weight based on the total amount of monomers, and is selected from the group consisting of acrylic acid, methacrylic acid, itaconic acid, and mixtures thereof.

13. The aqueous polymer dispersion of claim 8, wherein the hydrophobic polymer is a styrene/acrylate copolymer.

14. A method for producing an adhesive, the method comprising obtaining the polymer dispersion of claim 8.

15. A composite film produced from a first and at least a second polymer film which are bonded to one another using an adhesive comprising the aqueous polymer dispersion of claim 8.

16. The composite film of claim 15, wherein at least one of the polymer films is transparent.

17. A method for producing a composite film, the method comprising providing the aqueous polymer dispersion of claim 8 and bonding at least two films to one another using the aqueous polymer dispersion.
